(19) United States
(12) Patent Application Publication
(10) Pub. No.: US 2014/0062178 A1
(43) Pub. Date: Mar. 6, 2014

(54) METHOD AND SYSTEM FOR RELEASING PARKING BRAKE OF AN ANCHORED MACHINE AND A MACHINE WITH THE SAME

(71) Applicant: Caterpillar Inc., Peoria, IL (US)

(72) Inventors: Satchit Pradip Panse, Aurora, IL (US); Paul Watts, Dunlap, IL (US); Jinglian Sun, Jiangsu (CN); Frank Arriaga, Oswego, IL (US); Mark Thompson, Dekalb, IL (US)

(73) Assignee: Caterpillar Inc., Peoria, IL (US)

(21) Appl. No.: 14/015,065

(22) Filed: Aug. 30, 2013

(30) Foreign Application Priority Data
Sep. 5, 2012 (CN) 201210325474.4

(51) Int. Cl. B60T 7/20

(52) U.S. Cl. CPC B60T 7/20
USPC 303/18

(57) ABSTRACT

A method and system releases a spring parking brake of an anchored machine. A hydraulic fluid source is provided. A towing force is applied to the anchored machine, and the applied towing force is sensed by a sensor. The sensor sends a signal to a hydraulic fluid source control device. The hydraulic fluid source control device causes hydraulic fluid from the hydraulic fluid source to be supplied to the spring parking brake to release the spring parking brake.

### TECHNICAL FIELD

The present disclosure relates to a method and system for releasing a spring parking brake of an anchored machine so as to allow towing of the anchored machine and, in particular, towing of an anchored machine used in harsh or extreme environments. The disclosure further relates to a machine having the disclosed parking brake release system.

### BACKGROUND ART

For safety purposes, many industrial machines provide automatic fail-safe parking by using spring-driven, hydraulic-releasing parking or emergency braking methods. These braking systems are typically used with a power transmission system of a machine for emergency parking.

A machine equipped with a traditional spring-driven brake may have shortcomings in that it may not be easy to haul the failed machine away, especially in a harsh environment such as a mining or smelting environment. For example, in a metallurgical plant, if the machine is anchored in a slag hole, the anchored machine may be surrounded by melted slag so that workers cannot gain access to the machine or haul it away. In mining applications, access to the anchored machine may be limited, or the anchored machine may have to be towed to a repair area. Because workers are not allowed to work in an extreme environment, it may be difficult to repair or activate such an anchored machine. This is particularly important for remote-controlled or driverless machines for underground mining, because it may be difficult for a human to directly contact the machine.

US20070257551 discloses a system and method of remotely controlling an anchored vehicle to be towed by a towing vehicle, including equipping the towing vehicle with a pressurized hydraulic fluid source. The pressurized hydraulic fluid source of the towing vehicle is connected with a spring parking brake of the anchored vehicle by means of hydraulic lines, thus controlling operation of the parking brake of the anchored vehicle by the hydraulic fluid source of the towing vehicle. The towing vehicle is provided with a control valve and a manifold tank device for releasing an emergency brake, which provides a hydraulic fluid source having controlled pressure. In order to release or close the brake when necessary, the towing vehicle also has a means for controlling and monitoring flowing of the hydraulic fluid.

Although the towing vehicle described in US20070257551 can remotely control the spring parking brake of an anchored vehicle, a hydraulic fluid source has to be provided on the towing vehicle, and the hydraulic fluid source of the towing vehicle is connected to the parking brake of the towed vehicle manually through hydraulic lines to release the parking brake of the anchored vehicle. Consequently, a technical problem resulting therefrom is that a special towing vehicle is required to tow the anchored vehicle, and the connecting line cannot be mounted when the vehicle is anchored in a harsh environment, e.g., when the anchored vehicle is surrounded by slag in a melting plant, where the environment temperature is too high to access for performing the operation.

The disclosed method and system is intended to overcome one or more of the above problems.

### SUMMARY

In one aspect, the disclosure is directed to a method for releasing a spring parking brake of an anchored vehicle. The method may include providing a hydraulic fluid source, applying a towing force to the anchored machine, sensing the applied towing force, and sending a signal to a hydraulic fluid source control device. The hydraulic fluid source may be controlled by the hydraulic fluid source control device to supply hydraulic fluid to the spring parking brake to release the spring parking brake.

In another aspect, the disclosure is directed to a system for releasing a spring parking brake of an anchored vehicle. The system may include a hydraulic fluid source, a sensor configured for sensing a towing force applied to the anchored vehicle and sending a signal, and a control device configured for receiving the signal sent by the sensor and controlling the hydraulic fluid source. The control device may be configured to control the hydraulic fluid source to supply hydraulic fluid to the spring parking brake and release the spring parking brake to allow towing of the anchored machine.

In still another aspect, the disclosure is directed to a machine including a brake system having a spring parking brake, an accumulator, a spring sensor configured for sensing a towing force applied to the machine and sending a signal, and a control device configured for receiving the signal sent by the spring sensor and controlling the accumulator. The control device may be further configured to control the accumulator to supply hydraulic fluid to the spring parking brake to release the spring parking brake to allow towing of the anchored machine.

### BRIEF DESCRIPTION OF THE DRAWINGS

FIG. 1 is a schematic of an exemplary parking brake hydraulic system according to the disclosure showing a hydraulic circuit when the parking brake of the machine is in a brake released state;

FIG. 2 is a schematic of a portion of the parking brake hydraulic system of FIG. 1, showing a hydraulic circuit when the parking brake of the machine is in a braking state;

FIG. 3 is a schematic of a portion of the parking brake hydraulic system of FIG. 1, showing a hydraulic circuit when the parking brake of the anchored machine is in a brake released state by an additional accumulator; and

FIG. 4 is a schematic of a portion of the parking brake hydraulic system of FIG. 1, showing a hydraulic circuit when the parking brake of the anchored machine is in a braking state by an additional accumulator.

### DETAILED DESCRIPTION

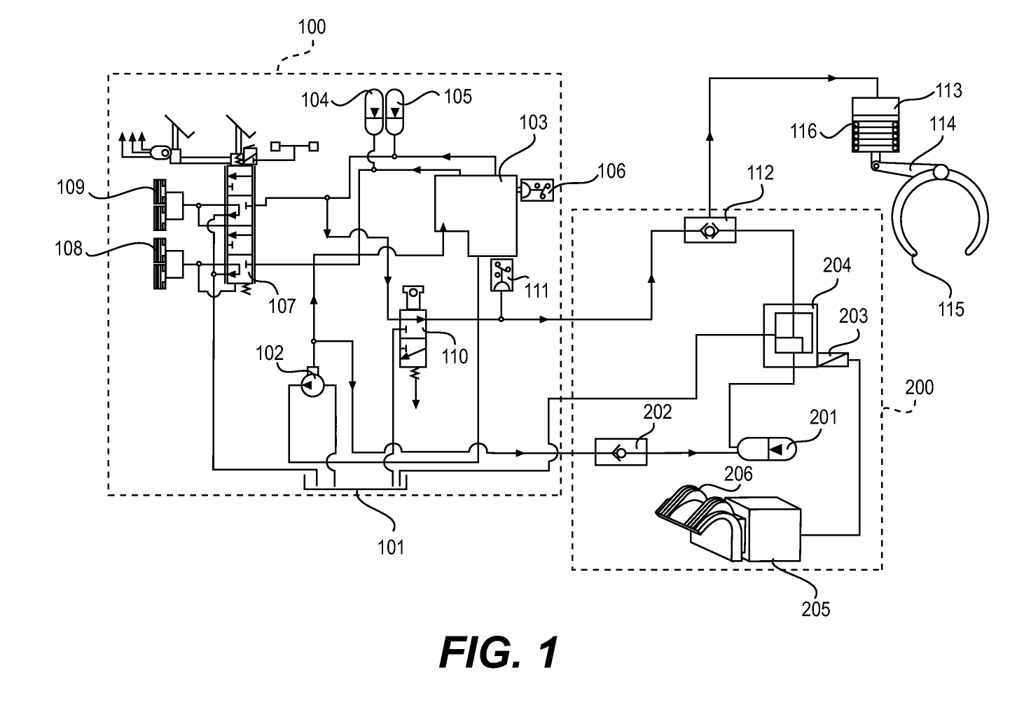

A brake system of a machine shown in FIG. 1 includes a common brake system 100 used by conventional machines and an additional parking brake releasing system 200, wherein the common brake system 100 includes a machine service brake system for braking during travelling of the machine and a machine parking brake system for applying a parking brake when the machine stops. The brake system can be used in various machines, such as a loader, a grader, an excavator, and other heavy machinery. The machine may be a bulldozer or any other type of machine associated with certain operations for special industries, such as mining, construction, agriculture, and transportation.

As shown in FIG. 1, the machine service brake system may include a hydraulic oil tank 101, an oil pump 102 configured for withdrawing oil from hydraulic oil tank 101 and outputting it into two branches each connecting to a pressurizing valve 103. The pressurizing valve may be connected to a front braking accumulator 104 and a rear braking accumulator 105 respectively. A braking pressure switch 106 may be connected with the pressurizing valve 103 to control pressure of the front braking accumulator 104 and the rear braking accumulator 105. The front braking accumulator 104 and the rear braking accumulator 105, respectively, may be connected, by means of a service brake valve 107, with a front axle brake 108 and a rear axle brake 109. Front axle brake 108 and rear axle brake 109 may be brake calipers or friction pads disposed in a driving device of the machine to implement service braking for the machine. A pedal may be depressed by an operator during service braking so that the service brake valve 107 controls the front brake accumulator 104 and the rear brake accumulator 105 to supply pressurized oil to the front axle brake 108 and the rear axle brake 109. The pressurized oil urges a brake caliper to engage a corresponding brake disc to brake the front and rear axles of the machine. The service brake valve 107 is simultaneously connected with the oil tank 101. In order to move the machine, the pedal may be released to discharge the pressurized oil into the oil tank 101 via a line connecting the service brake valve 107 and the oil tank 101. This depressurizes the front axle brake 108 and the rear axle brake 109 and releases the brake so that the machine is freely movable.

The machine parking brake system includes a hydraulic flow path introduced from the front brake accumulator 104 or the rear brake accumulator 105. The hydraulic flow path may be connected with the parking brake control valve 110, which may be connected with a parking brake drive 113 by means of a parking brake pressure control switch 111 and a shuttle valve 112. The parking brake drive 113 may be connected with a spring parking brake 115 via a link rod 114. In this implementation, the parking brake drive 113 may be a spring parking brake drive. The parking brake control valve 110 may be connected with the oil tank 101 simultaneously, and the pressurized oil in the parking brake drive 113 may be discharged into the oil tank 101 by means of the parking brake control valve 110.

Referring to FIGS. 1, 2, and 3, an additional parking brake release system 200 has an additional accumulator 201 connected to an output end of a pump 102. A one-way valve 202 may be disposed between the pump 102 and the additional accumulator 201 to prevent the pressurized oil of the additional accumulator 201 from refluxing to the common brake system 100 of the machine to avoid pressure loss. A manifold tank 204 having an electromagnetic valve 203 may be connected with the additional accumulator 201, and further connected with the shuttle valve 112 and the oil tank 101 via two separate branches, respectively. The shuttle valve 112 may be connected by a line with the parking brake drive 113. The parking brake drive 113 may be connected with the spring parking brake 115 by a link rod 114. The manifold tank 204 may be connected with the oil tank 101 via a line, and the oil pressure of the parking brake drive 113 may be discharged into the oil tank to prevent movement of the machine when required. The additional parking brake release system 200 may further include a sensor, e.g., a spring switch 205, which may be connected with a towing hook 206 mounted on rear of the machine. The spring switch (spring sensor) 205 may be connected to the electromagnetic valve 203. When the pulling force applied to the towing hook 206 exceeds a preset value, the spring switch connected with towing hook 206 may deformed and may generate an electrical signal that is sent to the electromagnetic valve 203 of the manifold tank 204. The sensor may be in other structures and the chief function and purpose thereof is to sense the towing force applied to the machine and generate a signal corresponding to a certain towing force.

### INDUSTRIAL APPLICABILITY

The method and system for releasing a parking brake of an anchored machine of the present disclosure may be applied in various machines, such as a loader, a grader, an excavator, and other heavy machinery. As shown in FIG. 1, when the machine is operating, the pump 102 withdraws oil from the oil tank 101 and pressurizes and supplies the oil to the front brake accumulator 104, the rear brake accumulator 105, and the additional accumulator 201. The pressurized oil is supplied to the accumulators by the accumulator pressurizing valve 103 under the control of the brake pressure switch 106, so that the brake system of the machine has sufficient hydraulic pressure. When a parking brake handle is pushed by an operator in the cab of the machine to release the parking brake, the parking brake control valve 110 is shifted downward mechanically to allow parking brake oil to flow through the shuttle valve 112 into the parking brake drive 113. This results in the spring 116 being compressed and the link rod 114 being moved downward to release the spring parking brake 115. Release of spring brake 115 may also release a transmission system of the machine and permit the machine to move. The parking brake pressure control switch 111 may send a signal to a control device of the transmission system to inform the control device that the spring parking brake 115 has been released and forward or backward shifting of gears can be controlled by the transmission.

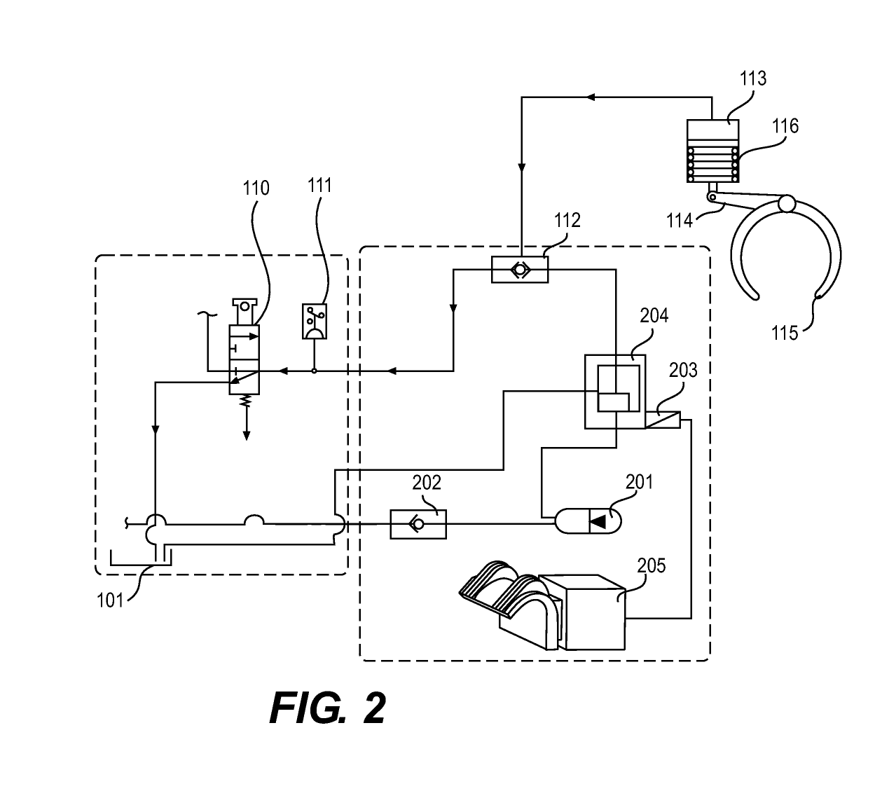

As shown in FIG. 2, an engine of the anchored machine may stop operation due to insufficient pressure inside the brake system. Alternatively, the operator in the cab of the machine may pull the brake stop handle forward to activate the parking brake. When the parking brake is activated, the parking brake control valve 110 may be moved upward mechanically to establish fluid communication between the parking brake drive 113 and the oil tank 101. In this position of parking brake control valve 110 the pressurized oil in the parking brake drive 113 may be directed to the oil tank 101 via the shuttle valve 112, with the pressure in the parking brake drive 113 being decreased. Spring 116 may then extend to urge the link rod 114 to move upward, thereby activating the spring parking brake 115 and locking the transmission system of the anchored machine to prevent the machine from moving. The pressure control switch of the spring parking brake 115 may send a signal to the control device of the transmission system to inform the control device that the spring parking brake 115 has been activated and the transmission system can no longer switch between forward and backward gear shifting.

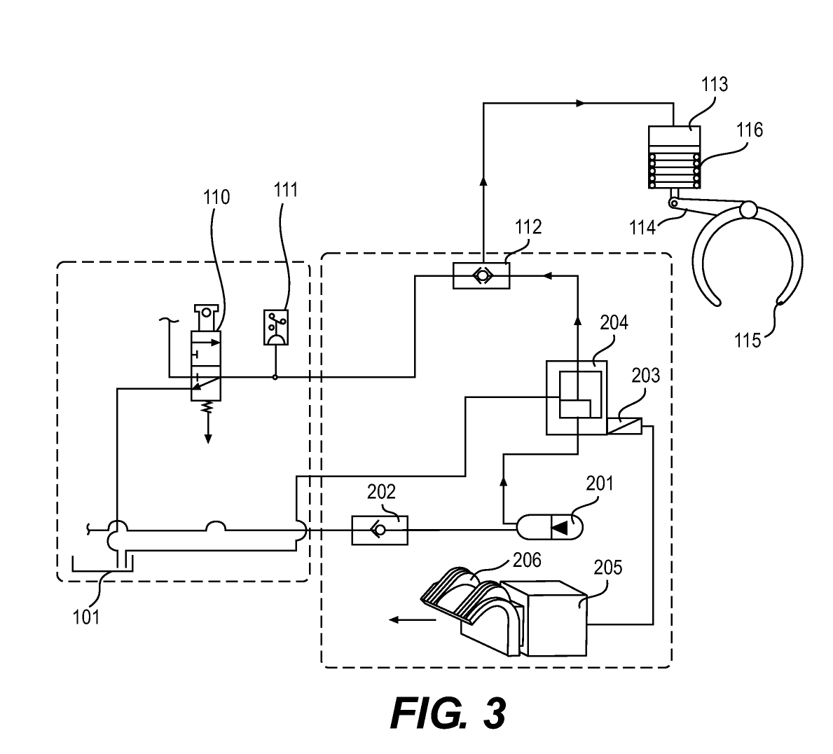

As shown in FIG. 3, when the anchored machine needs to be towed, a towing force is applied to the towing hook 206 at the rear of the machine, and this towing force is sensed by the spring switch 205 connected to towing hook 206. When the towing force exceeds a preset value of the spring switch 205, spring switch 205 may send a signal to electromagnetic valve 203 in manifold tank 204. Upon receiving a signal from spring switch 205, electromagnetic valve 203 may initiate fluid communication between manifold tank 204 and shuttle valve 112. Pressurized oil in the additional accumulator 201 may be directed to the parking brake drive 113 through an oil path in manifold tank 204 and via shuttle valve 112. The pressurized oil from the additional accumulator 201 overcomes a spring-applied force for holding the spring parking brake 115 at the parking position. Once the oil pressure exceeds the spring-applied force, the parking brake releases the braking, so that the transmission system resumes operating and the spring parking brake 115 will be released to allow the machine to move. The anchored machine can be towed for repair without being accessed by the operator.

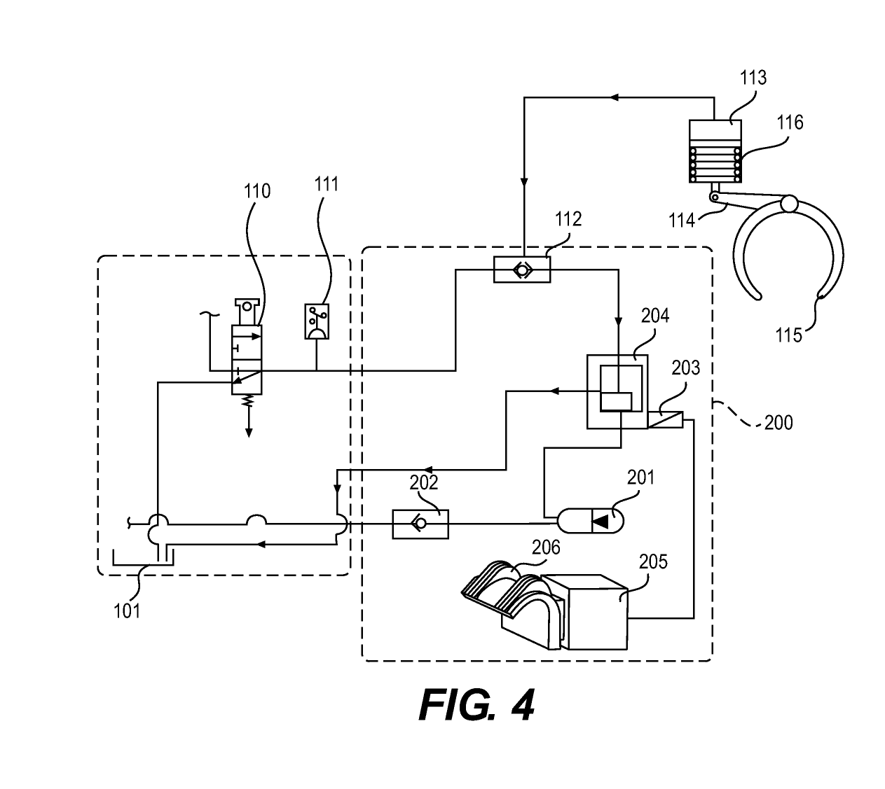

As shown in FIG. 4, when the anchored machine is towed to the repair area, the electromagnetic valve 203 controls the manifold tank 204 to communicate with the oil tank 101 via the line therebetween, and the pressurized oil in the parking brake drive 113 is directed into the manifold tank 204 through the shuttle valve 112, and is discharged into the oil tank 101. The pressure in the parking brake drive 113 decreases, and the spring 116 is extended to urge the link rod 114 to move upward to activate the spring parking drive 115, thereby locking the transmission system of the anchored machine to prevent movement of the machine.

It will be apparent to those skilled in the art that various modifications and variations can be made to the system and method of the present disclosure. Other embodiments will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A method for releasing a spring parking brake of an anchored machine, comprising:
providing a hydraulic fluid source;
applying a towing force to the anchored machine;
sensing the applied towing force and sending a signal to a hydraulic fluid source control device; and
controlling the hydraulic fluid source using the hydraulic fluid source control device to supply hydraulic fluid to the spring parking brake to release the spring parking brake.

2. The method according to claim 1, wherein the hydraulic fluid source is an accumulator and hydraulic fluid is supplied from the accumulator to the spring parking brake to release the spring parking brake.

3. The method according to claim 2, wherein:
hydraulic fluid is supplied to the accumulator by an oil supply pump of a brake system of the machine; and
a one-way valve is disposed between the accumulator and the oil supply pump for preventing hydraulic oil from refluxing to the brake system of the machine.

4. The method according to claim 1, wherein a spring switch senses a towing force and sends a signal to the hydraulic fluid source control device.

5. The method according to claim 1, wherein the hydraulic fluid source control device is an electromagnetic valve and the hydraulic fluid source is controlled by the electromagnetic valve to supply hydraulic fluid to the spring parking brake.

6. The method according to claim 1, wherein the towing force is applied to the rear of the anchored machine by a towing hook, and the towing force of the towing hook is sensed and a corresponding signal is generated by a sensor.

7. A system for releasing a spring parking brake of an anchored machine, comprising:
a hydraulic fluid source;
a sensor configured for sensing a towing force applied to the anchored vehicle and sending a signal; and
a control device configured for receiving the signal sent by the sensor and controlling the hydraulic fluid source to supply hydraulic fluid to the spring parking brake and release the spring parking brake to allow towing of the anchored machine.

8. The system according to claim 7, wherein the hydraulic fluid source is an accumulator.

9. The system according to claim 8, further including:
a brake system, the brake system including an oil supply pump;
an input end of the accumulator being connected to the oil supply pump; and
a one-way valve disposed between the accumulator and the oil supply pump for preventing hydraulic oil from refluxing to the brake system.

10. The system according to claim 7, wherein the sensor is a spring switch configured for sensing the towing force and sending a signal to the control device.

11. The system according to claim 7, wherein the control device is an electromagnetic valve configured for controlling the hydraulic fluid source to supply hydraulic fluid to the spring parking brake.

12. A machine, comprising:
a brake system, the brake system including a spring parking brake;
an accumulator;
a spring sensor configured for sensing a towing force applied to the machine and sending a signal; and
a control device configured for receiving the signal sent by the spring sensor and controlling the accumulator, and wherein the control device is configured for controlling the accumulator to supply fluid to the spring parking brake to release the spring parking brake to allow towing of the machine.

13. The machine according to claim 12, wherein the control device is an electromagnetic valve configured for controlling the accumulator to supply fluid to the spring parking brake.

14. The machine according to claim 12, further including a manifold tank positioned between the spring parking brake and the accumulator, the electromagnetic valve being disposed in the manifold tank to control the accumulator to supply fluid to the spring parking brake to release the spring parking brake, or to release the fluid in the spring parking brake into an oil tank to activate the spring parking brake.

15. The machine according to claim 12, further including a towing hook formed at a rear of the machine for towing the machine, and the spring sensor being connected to the towing hook to sense the towing force and send a signal.

16. The machine according to claim 12, further including:
a fluid tank; and
a fluid pump, wherein the fluid pump is configured for pressurizing and supplying fluid from the fluid tank to the accumulator.

17. The machine according to claim 16, further including a one-way valve interposed between the fluid tank and the accumulator to prevent the flow of fluid from the accumulator back into the fluid tank.

18. The machine according to claim 16, further including a parking brake control valve interposed between the fluid tank and the spring parking brake, the parking brake control valve configured to allow pressurized fluid to flow to the spring parking brake to release the spring parking brake.

19. The machine according to claim 16, further including a parking brake control valve interposed between the fluid tank and the spring parking brake, the parking brake control valve configured to allow pressurized fluid to flow from the spring parking brake to the fluid tank to activate the spring parking brake.

20. The machine according to claim 16, further including:
a transmission system;
a control device for the transmission system;
a parking brake control valve interposed between the fluid tank and the spring parking brake; and
a parking brake pressure control switch included in a fluid flow path between the parking brake control valve and the spring parking brake, the parking brake pressure control switch configured for sending a signal to the control device for the transmission system when fluid is supplied to the spring parking brake to release the spring parking brake, the signal sent from the parking brake pressure control switch to the control device for the transmission system informing the control device that the spring parking brake has been released and forward or backward shifting of gears can be controlled by the transmission.
